(19) United States
(12) Patent Application Publication
(10) Pub. No.: US 2026/0359119 A1
(43) Pub. Date: Nov. 12, 2026

(54) INTELLIGENT METHOD AND APPARATUS FOR OPTIMIZING COMPUTING RESOURCES CONFIGURATION THROUGH SOURCE CODE PROFILING USING QUANTUM-AI FOR CARBON FOOTPRINT REDUCTION

(71) Applicant: Bank of America Corporation, Charlotte, NC (US)

(72) Inventors: Manoj Dhanapal, KANCHIPURAM (IN); Manasa Krishna Gaddam, Hyderabad (IN); Shailendra Singh, Maharashtra (IN)

(21) Appl. No.: 19/199,652

(22) Filed: May 6, 2025

(51) Int. Cl. G06F 9/50

(52) U.S. Cl. CPC G06F 9/5027

(57) ABSTRACT

A system and method may use quantum AI to optimize a computing resources configuration used for performing a task with a reduced carbon footprint. Different iterations of source code for the same task may be developed in an integrated development environment and tested on DevOps. For each iteration, telemetry may be monitored, and metadata and deployment artifacts may be extracted and analyzed. A profile of a computing resources configuration needed by the source code, and correlations and dependencies between these computing resources may be determined for each source code iteration. Deployment artifacts may be parsed to construct one or more dependency graphs that reflect predicted energy consumption for executing the source code. Different simulated topology configurations may be invoked by different iterations of the source code. A source code iteration using an optimized computing resources configuration may be selected based on minimizing a carbon footprint while satisfying desired performance metrics.

### FIELD OF THE DISCLOSURE

Aspects of the disclosure relate to using artificial intelligence (AI) to optimize a configuration of computing resources for executing the source code for a computer program to reduce a carbon footprint of the source code.

### BACKGROUND OF THE DISCLOSURE

Modern computing systems, while functionally efficient, often operate without optimized resource allocation, service placement, and connectivity frameworks. This may lead to significant waste of energy and heightened carbon footprints. Existing methods of generating source code primarily focus on coding that provides performance and scalability of the computer systems. However, the existing methods lack an integrated approach that leverages code profiling to holistically determine the most environmentally sustainable system configurations.

It may be desirable to have a mechanism that dynamically aligns resource orchestration, service placement, and infrastructure with minimal environmental impact.

### SUMMARY OF THE DISCLOSURE

It is an object of this invention to provide an environmentally sustainable mechanism to generate source code that uses computing resources efficiently while harnessing AI for enhancing precision and adaptability of the source code.

A system and method in accordance with the present disclosure may be implemented by optimizing source code and optimizing usage of computing resources that execute the source code to limit energy consumption by the computing resources. The system may include an apparatus for implementing the present disclosure.

The system may include a quantum computer that includes a quantum processor: and a quantum AI engine that is configured to integrate with DevOps infrastructure for testing one or more iterations of source code for a computer program and for monitoring, in real time, code profiling telemetry emitted by the one or more iterations of the source code that are being tested.

The system may include a source code extraction engine that is configured to extract, by the quantum processor for the one or more iterations of the source code that are being tested, metadata about the respective iteration of the source code or computing resources used by the respective iteration of the source code and deployment artifacts associated with the respective iteration of the source code.

The system may include an integrated development environment (IDE) monitoring engine that is configured to monitor, by the quantum processor, an IDE, to ascertain a task to be implemented by the one or more iterations of the source code. The IDE monitoring engine may be configured to determine a first energy consumption threshold to limit energy consumption used by implementation of the source code based on the task to be performed by the source code.

The system may include a source code profiling engine that is configured to profile, by the quantum processor, the one or more iterations of the source code to analyze a respective topology configuration of the computing resources for executing the respective iteration of the source code and correlate relationships between computing resources used by the respective iteration of the source code and dependencies of the computing resources on each other. The source code profiling engine may be configured to parse the deployment artifacts to construct one or more dependency graphs that graph a dependency of the computing resources on each other. The one or more dependency graphs may be used to determine a total energy consumption in processing each of one or more iterations of the source code by the respective topology configuration of the computing resources compared to the first energy consumption threshold.

The system may include a computing resource optimization engine that is configured to simulate, by the quantum processor for a respective iteration, the plurality of respective topology configurations of computing resources that are available for executing the respective iteration of the source code and select an optimized topology configuration from the plurality of topology configurations based on one or more energy consumption-related performance metrics.

The system may include a dynamic computing resource deployment engine that is configured to dynamically deploy, by the quantum processor, the optimized topology configuration of computer resources to execute a selected one of one or more iterations of the source code. The system may deploy the selected one of the one more iterations of the source code that minimizes energy consumption. The deployment may be performed when the total energy consumption for the selected optimized respective iteration of the source code is below the first energy consumption threshold.

The IDE monitoring engine may be configured to raise the first energy consumption threshold to a second energy consumption threshold after a predetermined number of iterations of the one or more iterations of the source code are determined to not maintain the energy consumption at or below the first energy consumption threshold.

The source code profiling engine may be configured to determine, for respective iterations of the source code, the total energy consumption based on a respective energy consumption cost that has been assigned to each of the computing resources that are to be used to execute the iteration of the source code. The source code profiling engine may be configured to use a transformer-based profiling algorithm to analyze, for respective iterations of the source code, a topology configuration of the computing resources and correlate relationships between computing resources to be used by the respective iteration of the source code and dependencies of the computing resources on each other. The one or more dependency graphs constructed by the source code profiling engine may be constructed in a hybrid environment that includes a data center and a cloud for software development and testing, in an on-premises environment, or in an edge environment.

The computing resource optimization engine may be configured to leverage, for respective iterations of the source code, a quantum graph neural network (GNN) algorithm to simulate, predict and optimize computing resource configuration based on the dependency graphs. The computing resource optimization engine may include one or more real-time feedback loops that are configured to iteratively refine the potential topology configurations dynamically in real time to select from the potential topology configurations an optimized topology configuration that minimizes the carbon footprint for executing the source code by limiting the energy consumption. The computing resource optimization engine may be configured to optimize utilization of the computing resources based on bandwidth cost and security in addition to energy consumption.

The one or more energy consumption-related performance metrics may include one or more of latency, fault tolerance, or cost efficiency.

The system may include a carbon footprint monitoring engine that is configured to interact with the computing resource optimization engine, the IDE monitoring engine, or the IDE prompt engine to monitor the carbon footprint of the one or more iterations of the source code.

The system may include an IDE prompt engine that is configured to transmit a prompt, using an IDE interface and the quantum processor to a computing device that may be used, such as by a programmer, to modify one of the one or more iterations of the source code to adjust the source code to remain at or below the first energy consumption threshold to minimize a carbon footprint of the source code by reducing energy consumption.

A method in accordance with the present disclosure may optimize source code by optimizing usage of computing resources to reduce a carbon footprint. The method may include capturing, by a quantum AI engine on a quantum computer, code profiling telemetry emitted by a first iteration of source code developed in an integrated development environment (IDE) and tested as a simulation in real time on DevOps infrastructure. The method may include extracting, from the captured code profiling telemetry using a quantum processor of the quantum computer, metadata about the first iteration of the source code or computing resources used by the first iteration of the source code and deployment artifacts associated with the first iteration of the source code. The method may include profiling, by the quantum processor based on the metadata, the first iteration of the source code to analyze a configuration of the computing resources and correlate relationships between computing resources to be used in the first iteration and dependencies of the computing resources on each other.

The method may include parsing, by the quantum processor, the deployment artifacts to construct one or more dependency graphs that graph a dependency of the computing resources used by the first iteration of the source code on each other to determine a first energy consumption in processing the first iteration of the source code by the configuration of the computing resources. The method may include accepting, by the quantum processor, the first iteration of the source code for release when the first energy consumption is below a first predetermined energy consumption threshold.

The method may include transmitting a prompt, by the quantum processor to a computing device, to modify the first iteration of the source code to achieve a second energy consumption that is lower than the first energy consumption by optimizing usage of the computing resources. This may minimize the carbon footprint of the source code by reducing energy consumption. The method may include comparing, by the quantum processor, the first energy consumption to the first predetermined energy consumption threshold, and transmitting a prompt to a computing device when the first energy consumption is above the first energy consumption threshold.

The method may include optimizing, by the quantum processor, usage of the computing resources based on bandwidth cost and security in addition to energy consumption.

The method may include repeating the steps of capturing, extracting, profiling and parsing for a predetermined number of iterations of the source code in addition to the first iteration. The method may include raising, by the quantum processor, the first energy consumption threshold to a second energy consumption threshold after determining, by the quantum processor, that a predetermined number of iterations of the source code do not maintain the energy consumption at or below the first energy consumption threshold.

The method may include determining, by the quantum processor, the first energy consumption based on a respective energy consumption amount that has been assigned to each of the computing resources used by the first iteration of the source code.

The method may include using a transformer-based profiling algorithm processed by the quantum processor to analyze a configuration of the computing resources and correlate relationships between the computing resources used by the source code and dependencies of the computing resources on each other.

The method may include simulating, by the quantum processor, a plurality of configurations of computing resources and selecting an optimized configuration from the plurality of configurations based on one or more energy consumption-related performance metrics, which may include one or more of latency, fault tolerance, or cost efficiency.

The method may include leveraging a quantum GNN algorithm to simulate, predict and optimize the computing resource configuration based on the one or more dependency graphs.

The method may include deploying dynamically, by the quantum processor, a modification of the first iteration of the source code to update which of the computing resources are to be used to execute the source code. The modification may be a second iteration of the source code.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3 shows an illustrative system architecture that may be used in accordance with principles of the disclosure.

FIG. 4 shows an illustrative system architecture that may be used in accordance with principles of the disclosure.

FIG. 5 shows an illustrative graph showing examples of different levels of energy consumption by using different configurations of computing resources in accordance with principles of the disclosure.

FIGS. 6A, 6B, 6C and 6D together show features of an illustrative sample program that optimizes computing resource energy consumption for source code in accordance with principles of the disclosure.

FIG. 7 shows an illustrative flow chart for computing resource optimization in accordance with principles of the disclosure.

### DETAILED DESCRIPTION OF THE DISCLOSURE

A method and system may optimize a computing resources configuration to manage a carbon footprint based on source code profiling that leverages Quantum AI. The optimization may minimize the carbon footprint by monitoring and profiling the source code and selecting an energy-efficient configuration of computing resources for executing the source code, while factoring in performance and security. The optimization may provide feedback to a programmer in coding of source code to be more energy efficient. The optimization may impose changes to the source code to be more energy efficient.

The system may include an apparatus that has a dedicated Quantum AI engine operating on a quantum computer and that integrates with DevOps infrastructure to monitor source code telemetry in real-time. Source code telemetry may be telemetry generated by the source code, such as telemetry that is encoded in the source coding explicitly or is implicit from the source code. The quantum computer may use photonic quantum computing.

Metadata may be extracted from deployment artifacts and application source. A transformers algorithm may be used to analyze and correlate relationships between services, dependencies and configurations. Artifact parsing or source code-level insights combined with artifact parsing may be used to construct one or more dependency graphs in a hybrid environment to determine a carbon footprint impact. The hybrid environment may include a public cloud that may be used for development and testing and the deployment artifacts output from an existing data center.

The method may leverage code profiling telemetry/metrics like recursion depth, cyclomatic complexity to determine a complexity of a program, data mapping complexity with deployment artifacts to determine resource allocation, service placement, and network topology (configuration) requirements that have a minimum carbon footprint. The system may be integrated with quantum deep learning transformer models with code analysis metrics and deployment artifacts to predict a network topology that is needed to execute the processes specified in the source code. The method may leverage a GNN algorithm to simulate, predict and optimize computing resource configuration based on dependency graphs. Quantum GNNs may uniquely model the dynamic relationships between services and adapt the topology to minimize the carbon footprint while factoring in performance and security.

The use of Quantum AI-driven solvers and reinforcement learning models may simulate potential topologies and may iteratively refine the simulated potential topologies based on carbon footprint-factored performance metrics like latency, fault tolerance, and cost efficiency. The combination of simulation and optimization in a continuous feedback loop ensures that the system self-improves, rather than remaining static or being manually driven.

The method may automatically generate infrastructure configurations for computing resources and adapt to these configurations based on both code-level insights and artifacts analysis that may ensure a tailored deployment that minimizes the carbon footprint. The system thus provides a context-aware infrastructure configuration generator that has a self-learning mechanism combined with integration of real time monitoring and feedback loops to refine the topology configuration of computing resources dynamically in real time. This ensures that changes in application code and resource needs cause the topology to be updated in such a way that minimizes the carbon footprint.

The method and system may be versatile, applying to hybrid cloud, on premises, or edge environments. The network topology configuration may adapt not only to the immediate application's needs but also to broader operational constraints like bandwidth cost and security.

The method may prompt developers/programmers using an integrated development environment (IDE) interface on source code modification/refactoring to sustain derived optimized resource configuration to a point where the carbon footprint goal is within a specified threshold. The source code modification/refactoring exhaust method may derive a new computing resource configuration that makes a new carbon footprint that remains in equilibrium.

Illustrative embodiments of methods, systems, and apparatus in accordance with the principles of the invention will now be described with reference to the accompanying drawings, which form a part hereof. It is to be understood that other embodiments may be used, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The methods, apparatus, computer program products, and systems described herein are illustrative and may involve some or all the steps of the illustrative methods and/or some or all of the features of the illustrative system or apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

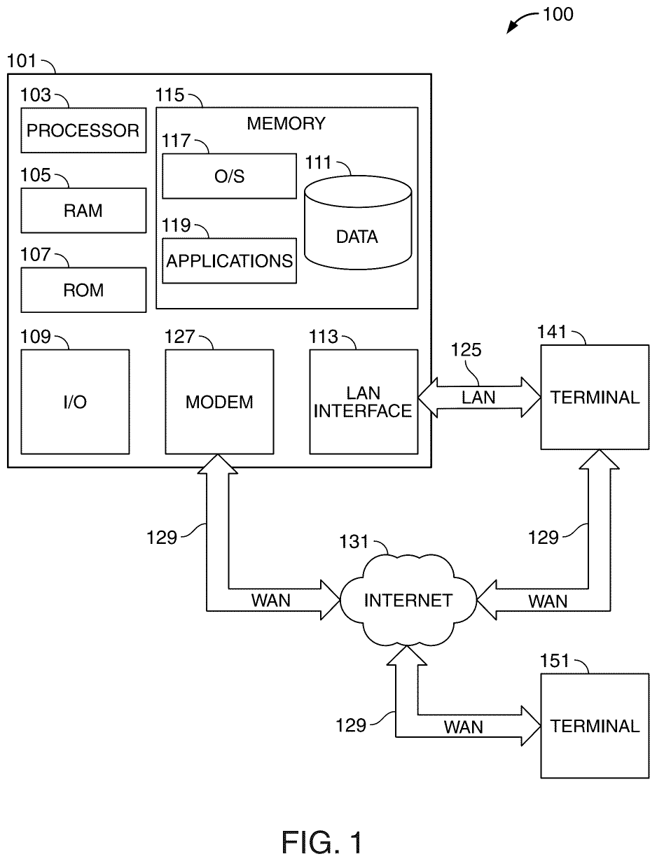

FIG. 1 shows an illustrative block diagram of system 100 that includes computer 101. Computer 101 may alternatively be referred to herein as an “engine,” “server” or a “computing device.” Computer 101 may be any computing device described herein, such as the computing devices running on a computer, smart phones, smart cars, smart cards, and any other mobile device described herein. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all the elements described above relative to computer 101.

In some embodiments, computer 101 and/or Terminals 141 and 151 may be any of mobile devices that may be in electronic communication with consumer device 106 via LAN, WAN, or any other suitable short-range communication when a network connection may not be established.

When used in a LAN networking environment, computer 101 is connected to LAN 125 through a LAN interface 113 or an adapter. When used in a WAN networking environment, computer 101 may include a communications device, such as modem 127 or other means, for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC (Near Field Communication), ZigBee, or any other suitable personal area network.

It will be appreciated that the network connections shown are illustrative and other means of establishing a communications link between computers may be used. The existence of various well-known protocols such as TCP/IP, Ethernet, NFT, HTTP, and the like is presumed, and the system can be operated in a client-server configuration to permit retrieval of data from a web-based server or API (Application Programming Interface). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may use one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may use the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry TM, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

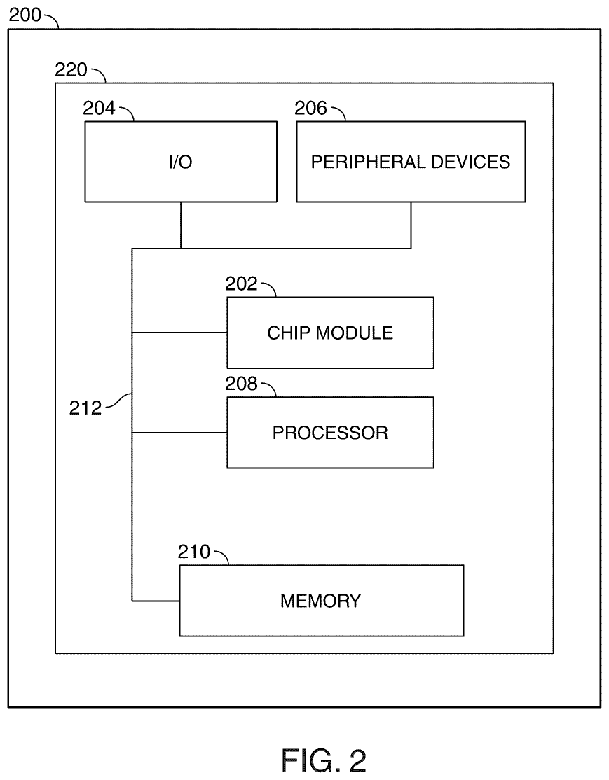

FIG. 2 shows illustrative apparatus 200, which may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY level hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

For the sake of illustration, the invention will be described as being performed by a “system.” The system may include one or more features of apparatus and methods that are described herein and/or any other suitable device or approach.

The system may include a quantum processor. A quantum processor may be used herein to refer to a computing device whose operations can harness aspects of quantum mechanics, such as superposition, interference, and entanglement. A quantum computer may deploy an AI engine that performs machine learning using an AI model.

Quantum processors are associated with vastly improved efficiencies over standard computers. Standard computers represent data in bits, which can be either 0 or 1. Quantum processors use qubits which utilize superposition (i.e., the ability to be in multiple states at the same time) to allow for a state of 0, 1, or any probability of being 0 or 1. The probabilities may be manipulated using matrix-based quantum gates, which are analogous to standard logic gates. Qubits are therefore able to represent many more data possibilities than a bit-based system of the same size. This allows for greater speed and less memory usage than standard systems.

The quantum computer may be a photonics quantum computer that stores the qubits as photons.

A qubit in a state of superposition may not have a defined value because it may hold many potential values at the same time. When measured, the qubit wave function collapses to a defined state. When an entangled qubit is in a state of superposition, each of its entangled connections is also in a state of superposition. These combinations of uncertainties exponentially increase the power of quantum processors.

The quantum processor may include a default number of quantum threads. Each quantum thread may include a default number of quantum circuits. Quantum circuits may refer to hardware and software based computational models that include quantum gates and are used for executing quantum computations.

In some embodiments, at least one of the quantum circuits may include a Toffoli gate. A feature of the Toffoli gate is its universal nature, meaning the structure is able to represent standard operations as well as quantum operations. In some embodiments, at least one of the quantum circuits may include a Hadamard gate. A feature of the Hadamard gate is the ability to represent a superposition state.

Quantum computing may be referred to as the use of quantum-mechanical phenomena such as superposition and entanglement to perform computations. The smallest bit in a quantum computing system may be called a qubit.

Executable instructions may be executed by an “N” qubit processor on a computer system. “N” may be a number between two and ten thousand.

The amount of data that a quantum computing system may be able to hold and manipulate may grow exponentially with the number of qubits included in the quantum computing system's processing core. A quantum computing system with “N” qubits may be able to simultaneously represent 2N states. Therefore, two qubits may hold four states, three qubits may hold eight states, fifty qubits may hold 1,125,899,906,842,624 states, and 10,000 qubits may hold 210000 states.

Other standard components of a computer system may be present, such as communication links, displays, input and output devices, read-only and random-access memory, and other components.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The non-transitory memory may be configured to store executable data configured to run on the “N”-qubit processor and/or a standard processor.

The “N” qubit processor or standard processors may control the operation of the computer system and its components, which may include RAM, ROM, an input/output module, and other memory.

Other components commonly used for computers, such as EEPROM or Flash memory or any other suitable components, may also be part of the apparatus and computer system.

A communication link may enable communication with other computers and servers, as well as enable the program to communicate with databases. The communication link may include any necessary hardware (e.g., antennae) and software to control the link. Any appropriate communication link may be used, such as Wi-Fi, Bluetooth, LAN, and cellular links. Multiple communication links may be present. In some embodiments, the network used to communicate may be the Internet. In some embodiments, the network may be an internal intranet or other internal network.

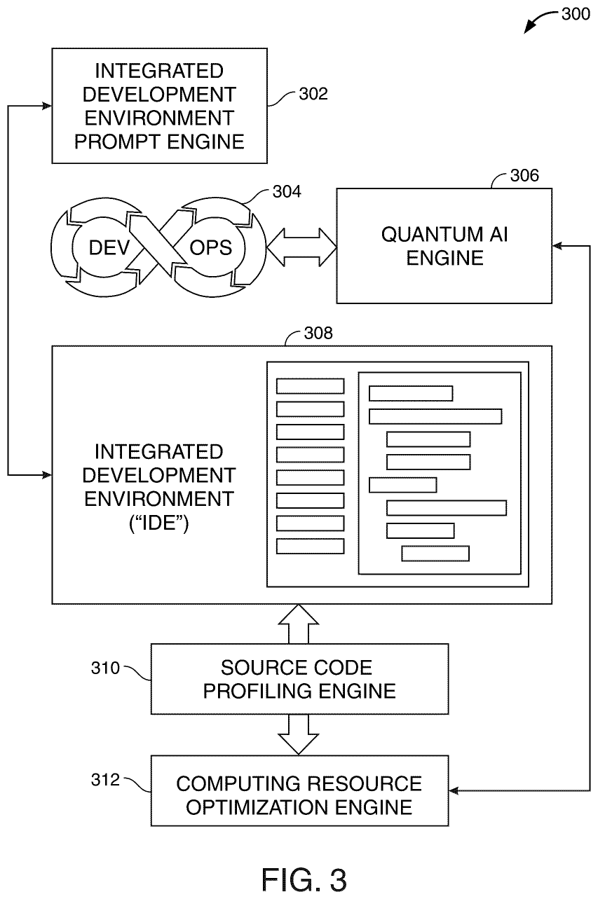

FIG. 3 shows an illustrative system architecture that may be used to provide a system 300 for optimizing computing resources to be used for implementing source code in accordance with principles of the disclosure. DevOps 304 may be used to enable integration and automation for managing and deploying computing infrastructure including computing resources.

A processor may be used to perform the optimization process in association with DevOps 304. The processor may be a quantum processor that may use a quantum AI engine 306 for the optimization process to be performed in association with DevOps 304. Using a quantum processor may increase the speed at which the optimization processing is performed, compared to a classical processor. The quantum processor may be integrated with DevOps 304 infrastructure to monitor source code telemetry in real time.

An Integrated Development Environment (IDE) 308 may be used for developing source code using a graphical user interface (GUI). The source code may include a list of computer commands to be performed in a computer-implemented application or a portion thereof. The IDE may determine an initial complexity of the source code and may determine a first threshold for expected power consumption. The IDE may offer a base code that may serve as a starting point for a programmer to add coding that results in the source code. The base code may have an initial complexity that is known to the IDE. The base code may consume a known amount of energy that may serve as an initial threshold for expected energy consumption for the source code to be generated or that may be used in generating an initial estimate of power consumption to determine a threshold for power consumption to be used in optimizing a configuration of computing resources for the source code. The IDE may be used to generate one or more iterations of the source code.

DevOps 304 may generate and output deployment artifacts, which may include coding, configurations, and other data that is needed to deploy a software application that has been developed. The deployment artifacts may be deployed as a file.

A source code profiling engine 310 may interface with IDE 308. Source code profiling engine 310 may be configured to profile, by the quantum processor, the source code. Source code profiling engine 310 may be configured to use a transformer-based profiling algorithm that uses an AI model, such as a quantum AI model, to analyze a configuration of the computing resources and correlate relationships between computing resources used by the source code and dependencies of the computing resources on each other. The transformer may be a machine learning transformer-based AI model, such as CodeBERT, GraphCodeBERT, or GPT Code (Models). CodeBERT is, for example, a pre-trained model designed for programming and natural language tasks.

Source code profiling engine 310 may parse deployment artifacts output from DevOps 304. Artifacts may include, for example, one or more of YAML (YAML Ain't Markup Language) files, docker files, JavaScript Object Notation (JSON) artifacts, or other configurations formats. The files may be converted into tokenized inputs, such as for inputs to codeBERT. The dependency graphs constructed by the source code profiling engine may be constructed in a hybrid environment comprising a data center and a cloud for software development and testing, in an on-premises environment, or in an edge environment.

The deployment artifacts may be used to construct dependency graphs that graph a dependency of the computing resources on each other. A dependency graph may be generated to show an amount of energy that would be consumed in processing a respective iteration of the source code based on a configuration of computing resources to be used. The amount of energy to be consumed for an iteration of source code may be compared to an energy consumption threshold.

The energy consumption threshold may be set to be a maximum that may be determined to be necessary to execute the specific source code. For example, the threshold may be initially set to 90 kW. This threshold may be based on a base code to which the programmer has added code. If, in this example, the source code is determined to need 100 kW to be executed, this iteration of the source code may not be considered acceptable. However, if efforts by the programmer and possibly other programmers as well to reduce energy consumption are unsuccessful, the threshold may be raised to a 95 kW or even a 100 kW threshold. Similarly, if the source code falls below the threshold, the threshold for the source code may be reduced for future iterations of the source code to try to further reduce energy consumption.

Source code profiling engine 310 may be configured to determine the total energy consumption by the specific source based on a respective energy consumption cost that has been assigned to each of the computing resources used by the iteration of the source code. The assignment of energy consumption cost may be determined based on actual testing of energy consumption of a computing resource, energy consumption specified by a manufacturer of the computing resource, or based on an estimated energy consumption.

Source code profiling engine 310 may be used to profile the source code for different possible configurations of computing resources that may be used. Where multiple iterations of the source code for a same application are tested, each iteration may cause a different configuration of computing resources to be selected for executing the source code. The total energy consumption for each of the iterations may be compared. The iteration with the lowest energy consumption may be selected. The iteration of computing resources that is selected may be based, not just on energy consumption, but on security, performance and other factors as well, such as one or more of latency, fault tolerance, or cost efficiency.

Source code profiling engine 310 may also be configured to produce one or more source code-level insights.

A computing resource optimization engine 312 may communicate with source code profiling engine 310 and quantum AI engine 306. Computing resource optimization engine 312 may simulate, by the quantum processor, potential topology configuration of computing resources for implementing a current iteration of the source code and may choose a topology configuration based on one or more energy consumption-related performance metrics determined by source code profiling engine 310. The metrics that may be relied upon may include one or more of bandwidth usage, response time, or fault tolerance.

Source code may be refined in iterations. When the source code is refined from one iteration to a different iteration of source code, a different topology configuration of computing resources may be selected for implementing the source code. The refinement may use one or more real-time feedback loops in engine 312 to iteratively refine the potential topology configurations dynamically in real time to select from the potential topology configurations an optimized topology configuration that minimizes the carbon footprint for executing the source code by limiting the energy consumption. The optimization of the configuration may be based on self-learning by the computer resource optimization engine 312 in conjunction with quantum AI engine 306. Computing resource optimization engine 312 may be further configured to optimize utilization of the computing resources based on other factors, such as bandwidth cost and security in addition to energy consumption.

An IDE prompt engine 302 may be configured to interact with IDE 308 and transmit a prompt, using an IDE interface and the quantum processor to a computing device of a programmer. The prompt may request one or more of the iterations of the source code be modified in IDE 308 to change the source code to remain at or below the predetermined energy consumption threshold to minimize a carbon footprint of the source code by reducing energy consumption.

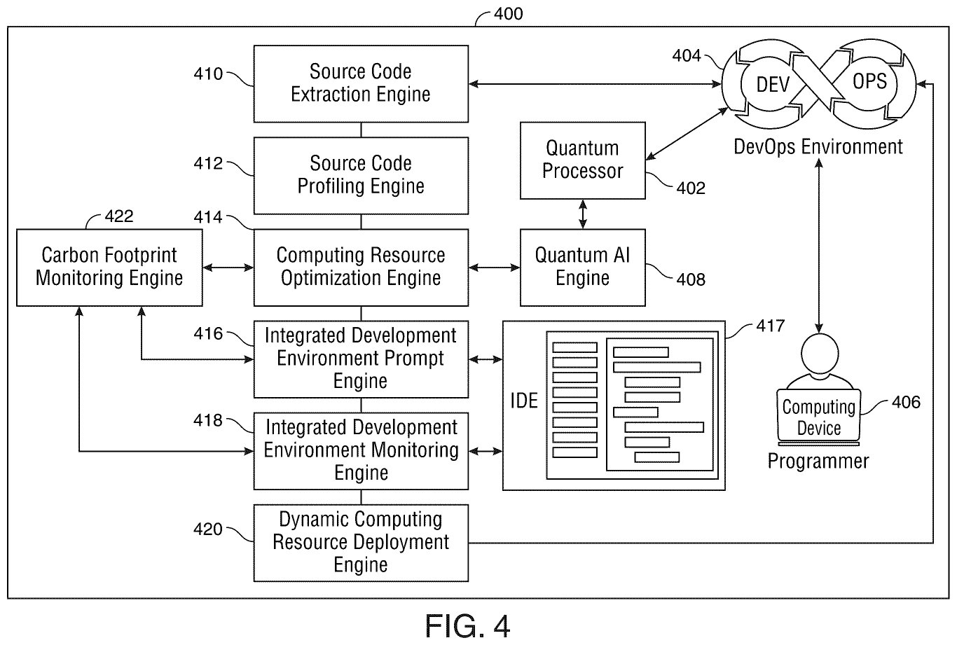

FIG. 4 shows illustrative system architecture 400 that may include some of the same engines including in the illustrative system architecture shown in FIG. 3 as well as additional engines that may be used to optimize computing resources based on energy consumption in accordance with principles of the disclosure.

A DevOps environment 404 may be used by a computing device 406 of a programmer to enable integration and automation for managing and deploying computing infrastructure including computing resources. A processor may be used to perform the optimization process in association with DevOps environment 404. The processor may be a quantum processor 402 that may use a quantum AI engine 408 for the optimization process to be performed in association with DevOps environment 404. Using a quantum processor 402 may increase the speed at which the optimization processing is performed compared to a classical processor. Quantum processor 402 may be integrated with DevOps environment 404 to monitor source code telemetry in real time, such as to actively monitor for new source code that has been written.

A source code extraction engine 410 may be configured to extract metadata about the source code or computing resources used by iterations of the source code and deployment artifacts associated with the iteration of the source code. Source code extraction may be performed by quantum processor 402. Source code that has been extracted, such as metadata, computing resources, or deployment artifacts, may be provided to source code profiling engine 412. Source code profiling engine 412 may parse the deployment artifacts output from DevOps 404 to construct dependency graphs that graph a dependency of the computing resources on each other. The dependency graphs may be provided to computing resource optimization engine 414.

Optimization engine 414 may simulate, using quantum processor 402, potential topology configurations of computing resources and iteratively refine them based on one or more energy consumption-related performance metrics. Optimization engine 414 may examine the source code using the quantum AI engine and may be able to determine an optimal configuration of computing resources to be used. In considering optimization, optimization engine 414 may consider the task(s) being performed by the source code and may identify, for example, unnecessary calls by the source code for use of computing resources. Optimization engine 414 may be configured to identify unnecessary or incorrect coding and may modify the source code to eliminate unnecessary coding or fix faulty source code, where possible.

IDE prompt engine 416 may interact with IDE 417 and transmit a prompt, using an IDE interface and the quantum processor to computing device 406, such as a computing device of a programmer, that requests that IDE 417 modify one or more of the iterations of the source code to adjust the source code to remain at or below the energy consumption threshold (a baseline) to minimize a carbon footprint of the source code by reducing energy consumption. While a single computing device 406 with a single programmer is shown interacting with DevOps environment 404, there may be multiple programmers working on the source code. The programmers may have separate computing devices in communication with DevOps.

Source code profiling engine 412, computing resource optimization engine 414 and integrated development environment (IDE) prompt engine 416 may be configured similar to respective engines source code profiling engine 310, computing resource optimization engine 312, and IDE prompt engine 302, described above.

Additionally, an integrated development environment (IDE) monitoring engine 418 may be configured to monitor, such as by the quantum processor, IDE 417 to ascertain tasks to be implemented by the source code. IDE monitoring engine 418 may determine an energy consumption threshold to limit energy consumption used by implementation of the source code based on the tasks, or a different engine may determine the energy consumption threshold.

A dynamic computing resource deployment engine 420 may receive energy consumption information from IDE monitoring engine 418. Dynamic computing resource deployment engine 420 may be configured to deploy, by quantum processor 402, one of multiple configurations of the computing resources that reduce energy consumption in executing the source code, such as based on which computing resource configuration maintains the lowest energy consumption for executing the source code. The modification of the source code may be made by a programmer at computing device 406 or may be an automatically attempted modification of the source code by quantum processor 402.

A carbon footprint monitoring engine 422 may be configured to monitor the carbon footprint of the computing resources that are mapped to the source code during optimization of computing resources by computing resource optimization engine 414. Monitoring engine 422 may monitor each iteration of the source code. After modification of source code, which may change the amount of energy consumption used in executing the source code, the energy consumption by the modified source code may be “refactored,” such as by computing resource optimization engine 414 to reassess a modified amount of energy consumption and how the revised energy consumption compares to energy consumption for other iterations of the source code. Carbon footprint monitoring engine 422 may interact with one or more of computing resource optimization engine 414, IDE prompt engine 416, or IDE monitoring engine 418.

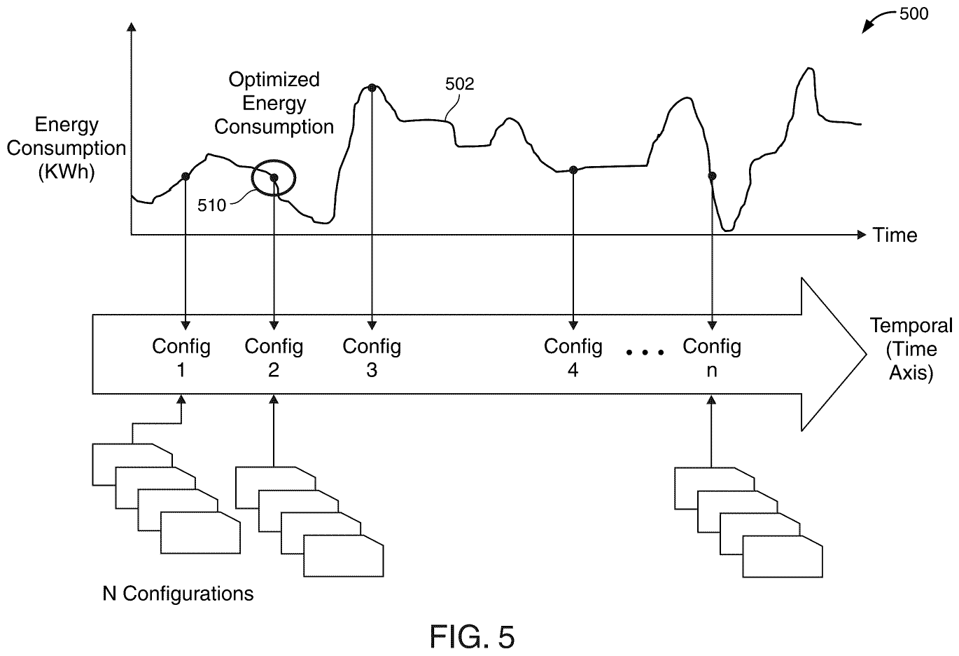

FIG. 5 shows an illustrative example of a graph in which the source code may have been iterated n times over a period of time. The iterations may be by the same programmer or computing device or by a different programmer or computing device. The time line may vary so that the time between iterations may be, for example, a few hours, days or months. The time between iterations may also vary. For each iteration of the source code, there may be one or more possible configurations of computing resources that are possible for use with the source code. There may be, for example, N possible configurations for an iteration of the source code. The optimization engine may choose the configuration for each iteration that is most energy efficient and below (or no larger than) the maximum energy consumption threshold, when there are one or more configurations that are below the maximum energy consumption threshold.

When the total energy consumption for a configuration of computing resources to be used for executing an iteration of source code is below a predetermined threshold, the source code for that iteration may be finalized and released for deployment. Or a total energy consumption may be measured for multiple iterations of the source code and the iteration of source code selected for deployment may be selected based on energy consumption relative to other iterations of the source code. A notification may be sent by the quantum processor to the computer device of the programmer. An indicator, such as a green button, may be displayed on a screen of a programmer's computing device to allow that iteration of the source code to be finalized for release. An indicator, such as a red button, may be displayed on a screen of a programmer's computing device to indicate that the source code is above the allowed energy consumption threshold. In this case, the source code is blocked by the quantum processor from being released and cannot be finalized without modification of the source code or without a change in the energy consumption threshold that controls whether the source code may be finalized.

The continuous line 502 on graph 500 may represent energy consumption changes that may have taken place as the computing resources were adjusted from one configuration to the next. In FIG. 5, configuration 2 may be determined, such as by computing resource optimization engine 414, to use an optimized level of energy consumption at 510 compared to other configurations, such as configurations 1, 3, 4, . . . N, that were considered. The optimized level of energy consumption that may be selected may be based not only on energy consumption but also on other factors, such as one or more of bandwidth cost, security, latency, fault tolerance, or cost efficiency.

Energy consumption may be measured based on consumption by various computing resources used to perform operations specified in the source code. For example, energy consumption F may be specified based on usage of the following specified computing resources:
F(Energy consumption (KWh))=CPU utilization, Memory Usage (MB/GB), Network data transfer (GB), Storage Usage (GB), Execution time (s or ms), Number of active users, Infrastructure setup (Cloud/Local).

Energy consumption by energy-consuming computing resources other than those specified may also be considered in calculating an amount of energy consumption F.

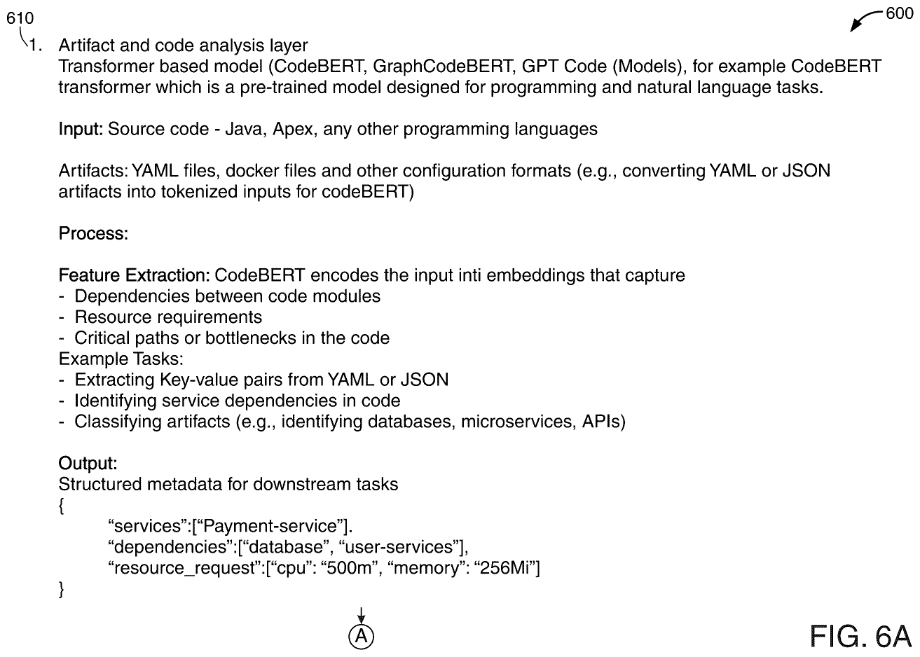

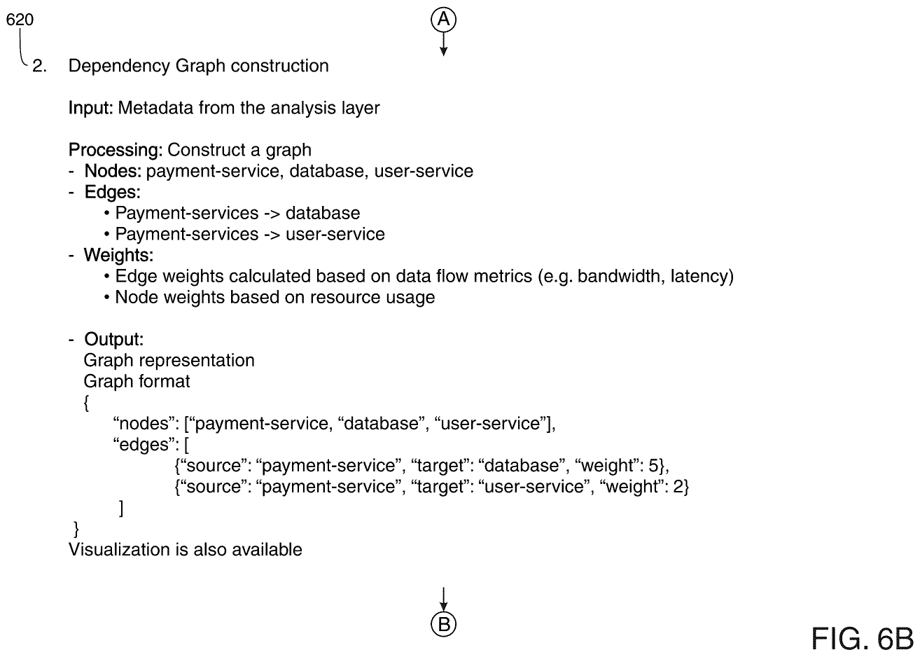

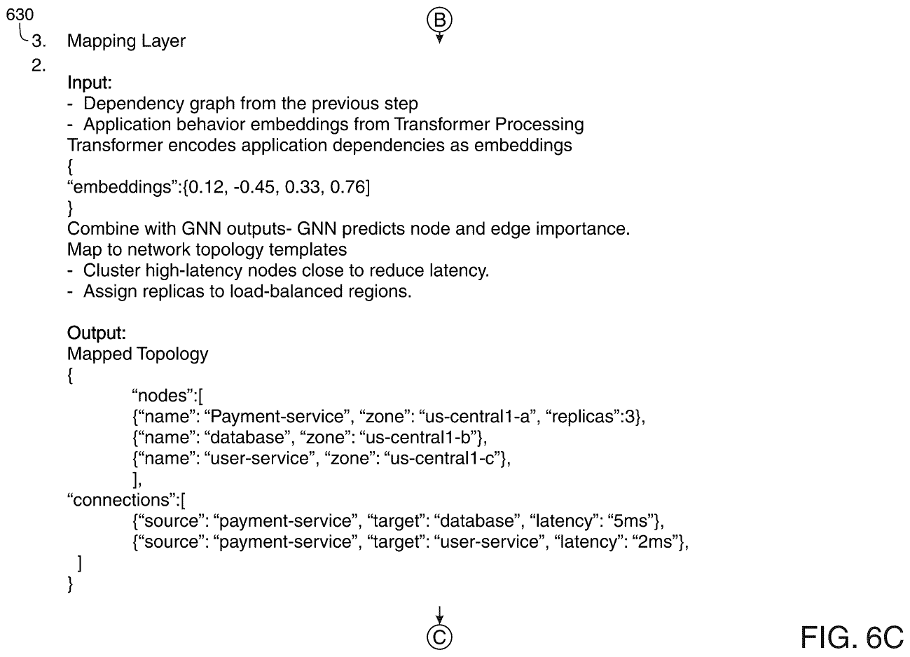

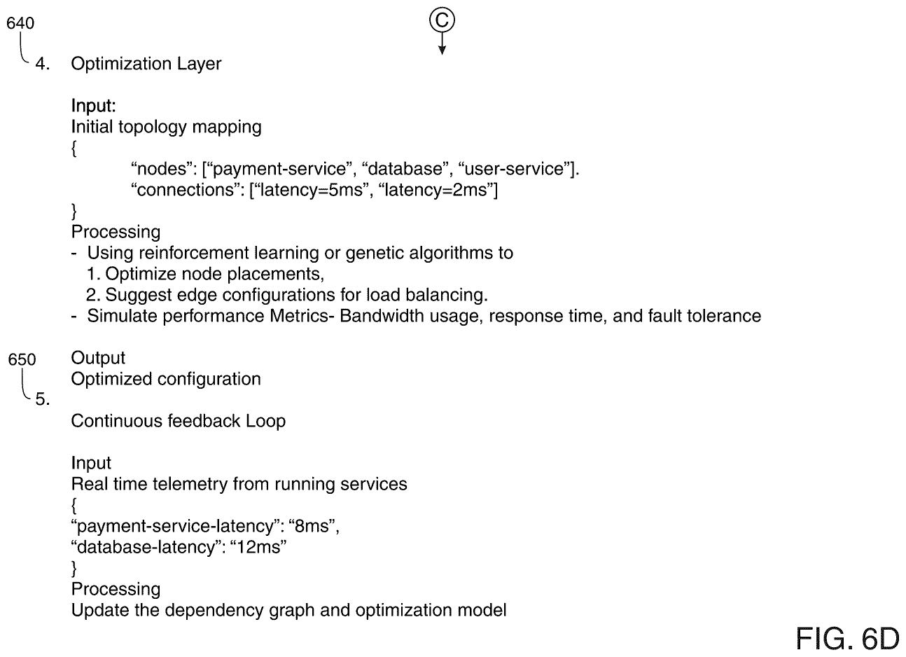

FIGS. 6A, 6B, 6C and 6D together show features of an illustrative sample program 600 that optimizes computing resources to reduce energy consumption for source code in accordance with principles of the disclosure. The illustrative features may be performed using a quantum AI engine implemented on a quantum computer.

FIG. 6A shows features of an illustrative artifact and code analysis layer 610 of sample program 600 that may be programmed to analyze source code and artifacts and output structured metadata. In embodiments, artifact and code analysis layer 610 may be performed by a source code profiling engine. Source code may be written in one of various programming languages, such as Java, Apex, or another programming language. Artifacts may be received in a file, such as one or more of YAML files, docker files, or other configuration formats. A transformer-based model may be used to transform the input code and artifacts into the structured metadata that may be output. The transformer-based model may be, for example, a machine learning transformer-based AI model, such as CodeBERT, GraphCodeBERT, or GPT Code (Models). CodeBERT is, for example, a pre-trained model designed for programming and natural language tasks.

The transformer, such as CodeBERT, may be used for feature extraction. The transformer may encode the input initial embeddings within the code and artifacts to capture dependencies between code modules, resource requirements, and critical paths or bottlenecks in the source code. For example, the transformer may extract key-value pairs of a key identifiers and associated data from the YAML file or the JSON artifacts. The transformer may identify service dependencies in the code. The transformer may classify artifacts into classes of data such as identifying databases, microservices, or application programming interfaces (APIs).

Outputs from the transformer may include structured metadata for downstream tasks. For example, the output may include services, such as a payment-service, dependencies, such as a dependency between a database and user services, and a resource_request for executing the source code, such as a request for a particular usage of a CPU (e.g., 500 m) and an amount of memory (e.g., 256 Mi). The usage of the CPU or the amount memory may be specified to indicate a maximum level of computing resources that may be used, thereby possibly limiting the energy consumption by the CPU or memory.

FIG. 6B shows features of an illustrative dependency graph construction 620 in sample program 600 that may be programmed to perform on the metadata by the artifact and code analysis layer 610 to generate the dependency graph. Dependency graph construction 620 may be performed after artifact and code analysis is performed. In embodiments, dependency graph construction 620 may be performed by the source code profiling engine.

To construct the dependency graph, nodes, edges, and weights may be determined. Nodes may include one or more nodes for payment-services, database, and user-service. Edges to be determined may include edges for a database and user-services based on payment-services. Edge weights may be calculated based on data flow metrics, such as, for example, bandwidth and latency. Node weights may be based on resource usage. The output may be a dependency graph. Graph may take the format of:

```
“nodes”: [“payment-service, “database”, “user-service”],
“edges”: [
  {“source”: “payment-service”, “target”: “database”, “weight”: x},
  {“source”: “payment-service”, “target”: “user-service”, “weight”: y}
]
```

In one example, x may be assigned a value of 5, and y may be assigned a value of 2. The dependency graph may be specified in a graph format. A visualization of the graph may be displayed to a programmer on a computing device.

FIG. 6C shows features of an illustrative mapping layer 630 of sample program 600 that may be programmed to perform mapping of values on the dependency graph to a topology of available nodes and computing resources. In embodiments, mapping layer 630 may be performed by a computing resource optimization engine. Application behavior embeddings from transformer processing in 610 may be input. The transformer may have encoded application dependencies as embeddings. Embeddings may be specified, for example, in a format such as:

{
“embeddings”: {0.12, −0.45, 0.33, 0.76]
}

Embeddings may be combined with GNN outputs, where GNN may predict node and edge importance. Embeddings combined with GNN outputs may be mapped to network topology templates such high-latency nodes are clustered close to one another to reduce latency. Replicas of data may be assigned to load-balanced regions of the network.

The output of mapping layer 630 may provide a mapped topology. The topology may be output, for example, in the following format and may include specified zones:

```
  “nodes”:[
  {“name”: “Payment-service”, “zone”: “us-central1-a”, “replicas”:3},
  {“name”: “database”, “zone”: “us-central1-b”},
  {“name”: “user-service”, “zone”: “us-central1-c”},
  ],
“connections”:[
  {“source”: “payment-service”, “target”: “database”, “latency”:
  “5ms”},
  {“source”: “payment-service”, “target”: “user-service”, “latency”:
  “2ms”},
  ]
```

The values of the variables are shown as examples.

FIG. 6D shows features of an illustrative optimization process in sample program 600 that may be performed by an optimization layer 640 on the initial topology mapping of mapping layer 630 to output an optimized computing resource configuration. In embodiments, mapping layer 630 may be performed by one or more real-time feedback loops in a computing resource optimization engine.

In the example of FIG. 6C, an initial topology mapping may be as follows:
“nodes”: [“payment-service”, “database”, “user-service”]. “connections”: [“latency=5 ms”, “latency=2 ms”]

In optimization layer 640, reinforcement learning or genetic algorithms may be used to optimize node placement and suggest edge configurations for load balancing. Additionally, performance metrics, such as bandwidth usage, response time, and fault tolerance, may be simulated to determine an optimized configuration.

FIG. 6D further lists features of an illustrative continuous feedback loop 650 of sample program 600 in which real time telemetry from currently running services, such as latency values, are used to update the dependency graph and optimization model. For example, payment-service-latency may be 8 ms and database-latency may be 12 ms and may be used to update the dependency graph and optimization model. The feedback may be operated continuously or for a predetermined number of feedback cycles. For example, source code may be iterated for 10 cycles to try to reduce energy consumption by the source code. After that, if no iteration of the source code is below the predetermined energy consumption threshold, the threshold may be changed.

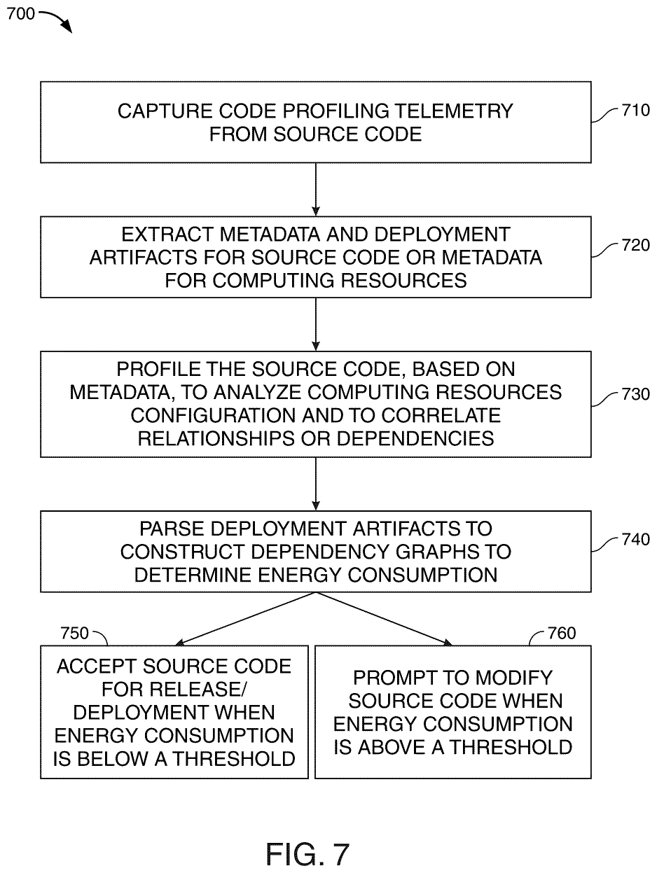

FIG. 7 shows an illustrative flow chart for computing resource optimization in accordance with principles of the disclosure.

At step 710, profiling telemetry may be captured from an iteration of source code. At step 720, metadata and deployment artifacts for the source code and metadata for computing resources may be extracted from the telemetry. At step 730, the source code may be profiled based on the extracted metadata to analyze available computing resources configurations and to correlate relationships or dependencies of the computing resources. At step 740, the deployment artifacts may be parsed to construct one or more dependency graphs that may be used to determine energy consumption of the iteration of source code is performed on a configuration of computing resources.

At step 750, the system may accept the source code for release/deployment when the energy consumption is smaller than a threshold of allowed energy consumption.

Feedback may be provided where the source code does not meet energy consumption goals, such as for carbon footprint minimization. At step 760, the system may transmit a prompt to the computing device of the programmer to prompt the programmer to modify the iteration of the source code has an energy consumption that is larger than (or is equal to or larger than) a threshold of allowed energy consumption. The prompt may include an alert that the source code will consume an excessive amount of energy. Where the source code is determined to not use excessive energy and to be acceptable for release, the computing device of the programmer may receive a notification of that determination and the source code may be released for deployment.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for optimizing a computing resources configuration through source code profiling using Quantum-AI for carbon footprint reduction may be provided. Persons skilled in the art will appreciate that the present invention can be practiced by other than the described embodiments, which are presented for purposes of illustration rather than of limitation.

What is claimed is:

1. A system for optimizing source code and optimizing usage of computing resources that execute the source code to limit energy consumption by the computing resources, the system comprising:
a quantum computer comprising:
a quantum processor: and a quantum artificial intelligence (AI) engine that is configured to integrate with DevOps infrastructure for testing one or more iterations of source code and for monitoring, in real time, code profiling telemetry emitted by the one or more iterations of the source code that are being tested;
a source code extraction engine that is configured to extract, by the quantum processor for the one or more iterations of the source code, metadata about the respective iteration of the source code or computing resources used by one or more iterations of the source code and deployment artifacts associated with the iteration of the source code;
an integrated development environment (IDE) monitoring engine that is configured to monitor, by the quantum processor, an IDE, to ascertain a task to be implemented by the one or more iterations of the source code, and determine a first energy consumption threshold to limit energy consumption used by implementation of the source code based on the task;
a source code profiling engine that is configured to:
profile, by the quantum processor, the one or more iterations of the source code to analyze a respective topology configuration of the computing resources of a plurality of possible topology configurations for executing the respective iteration of the source code and correlate relationships between the computing resources used by the respective iteration of the source code and dependencies of the computing resources on each other for the respective iteration of the source code; and
parse the deployment artifacts to construct one or more dependency graphs that graph the dependencies of the computing resources on each other for the respective iteration of the source code to determine a total energy consumption in processing the respective iteration of the source code using the respective topology configuration of the computing resources compared to the first energy consumption threshold;
a computing resource optimization engine that is configured to:
simulate, by the quantum processor, the use of one or more of the plurality of possible topology configurations of computing resources for executing the respective iterations of the source code; and
select an optimized respective iteration of the source code and an optimized topology configuration for the selected optimized respective iteration of the source code from the plurality of topology configurations from the one or more iterations of the source code based on one or more energy consumption-related performance metrics; and
a dynamic computing resource deployment engine that is configured to deploy, by the quantum processor, the optimized topology configuration of computer resources to execute the source code when the total energy consumption for the selected optimized respective iteration of the source code is below the first energy consumption threshold.

2. The system of claim 1, wherein the IDE monitoring engine is further configured to raise the first energy consumption threshold to a second energy consumption threshold after a predetermined number of the one or more iterations of the source code are determined to not maintain the energy consumption at or below the first energy consumption threshold.

3. The system of claim 1, wherein the source code profiling engine is further configured to determine, for respective iterations of the source code, the total energy consumption based on a respective energy consumption cost that has been assigned to each of the computing resources that are to be used to execute the iteration of the source code.

4. The system of claim 1, wherein the source code profiling engine is further configured to use a transformer-based profiling algorithm to analyze the configuration of the computing resources and correlate the relationships between the computing resources to be used by the respective iteration of the source code and dependencies of the computing resources on each other.

5. The system of claim 1, wherein the one or more dependency graphs constructed by the source code profiling engine are constructed in a hybrid environment comprising a data center and a cloud for software development and testing, in an on-premises environment, or in an edge environment.

6. The system of claim 1, wherein the computing resource optimization engine is further configured to leverage a quantum graph neural network (GNN) algorithm to simulate, predict and optimize computing resource configuration based on the one or more dependency graphs.

7. The system of claim 1, wherein the computing resource optimization engine comprises one or more real-time feedback loops that are configured to iteratively refine the potential topology configurations dynamically in real time to select from the potential topology configurations an optimized topology configuration that minimizes the carbon footprint for executing the source code by limiting the energy consumption.

8. The system of claim 1, wherein the computing resource optimization engine is further configured to optimize utilization of the computing resources based on bandwidth cost and security in addition to the energy consumption.

9. The system of claim 1, wherein the one or more energy consumption-related performance metrics comprises one or more of latency, fault tolerance, or cost efficiency.

10. The system of claim 1, further comprising a carbon footprint monitoring engine that is configured to interact with the computing resource optimization engine, the IDE monitoring engine, or the IDE prompt engine to monitor the carbon footprint of one or more iterations of the source code.

11. The system of claim 1, further comprising an IDE prompt engine that is configured to transmit a prompt, using an IDE interface and the quantum processor to a computing device of a programmer, to modify one of the one or more iterations of the source code to adjust the source code to remain at or below the first energy consumption threshold to minimize a carbon footprint of the source code by reducing energy consumption.

12. A method of optimizing source code by optimizing usage of computing resources to reduce a carbon footprint, the method comprising:
capturing, by a quantum artificial intelligence (AI) engine on a quantum computer, code profiling telemetry emitted by a first iteration of source code developed in an integrated development environment (IDE) and tested as a simulation in real time on DevOps infrastructure;
extracting, from the captured code profiling telemetry using a quantum processor of the quantum computer, metadata about the first iteration of the source code or computing resources used by the first iteration of the source code and deployment artifacts associated with the first iteration of the source code;
profiling, by the quantum processor based on the metadata, the first iteration of the source code to analyze a configuration of the computing resources and correlate relationships between computing resources to be used in the first iteration and dependencies of the computing resources on each other; and
parsing, by the quantum processor, the deployment artifacts to construct one or more dependency graphs that graph a dependency of the computing resources used by the first iteration of the source code on each other to determine a first energy consumption in processing the first iteration of the source code by the configuration of the computing resources.

13. The method of claim 12, further comprising:
accepting, by the quantum computer, the first iteration of the source code for release when the first energy consumption is below a first predetermined energy consumption threshold.

14. The method of claim 12, further comprising
transmitting a prompt, by the quantum processor to a computing device, to modify the first iteration of the source code to a second iteration of the source code to achieve a second energy consumption that is lower than the first energy consumption by optimizing usage of the computing resources.

15. The method of claim 12, further comprising:
comparing, by the quantum processor, the first energy consumption to the first predetermined energy consumption threshold, and transmitting a prompt to a computing device, when the first energy consumption is above the first energy consumption threshold.

16. The method of claim 12, further comprising optimizing, by the quantum processor, usage of the computing resources based on bandwidth cost and security in addition to energy consumption.

17. The method of claim 12, further comprising:
repeating the steps of capturing, extracting, profiling and parsing for a predetermined number of iterations of the source code in addition to the first iteration; and
raising, by the quantum processor, the first energy consumption threshold to a second energy consumption threshold after determining, by the quantum processor, that the predetermined number of iterations of the source code in addition to the first iteration do not maintain an energy consumption by computing resources for the iterations of the source code in addition to the first iteration at or below the first energy consumption threshold.

18. The method of claim 12, further comprising using a transformer-based profiling algorithm processed by the quantum processor to analyze a configuration of the computing resources and correlate relationships between the computing resources used by the first iteration of the source code and dependencies of the computing resources on each other.

19. The method of claim 12, further comprising simulating, by the quantum processor, a plurality of configurations of computing resources and selecting an optimized configuration from the plurality of configurations based on one or more energy consumption-related performance metrics wherein the one or more energy consumption-related performance metrics comprises one or more of latency, fault tolerance, or cost efficiency.

20. The method of claim 12, further comprising:
leveraging a quantum graph neural network (GNN) algorithm to simulate, predict and optimize computing resource configuration based on the one or more dependency graphs.
